(19) United States
(12) Patent Application Publication
(10) Pub. No.: US 2012/0217918 A1
(43) Pub. Date: Aug. 30, 2012

(54) INVERTER

(75) Inventors: Robert Januschevski, Tettnang (DE); Kai Borntrager, Langenargen (DE)

(73) Assignee: ZF FRIEDRICHSHAFEN AG, Friedrichshafen (DE)

(21) Appl. No.: 13/508,428

(22) PCT Filed: Oct. 29, 2010
(86) PCT No.: PCT/EP10/66425

§ 371 Date: May 7, 2012

(30) Foreign Application Priority Data
Nov. 11, 2009 (DE) 10 2009 046 616.9

(51) Int. Cl. H02P 6/14

(52) U.S. Cl. 318/400.27

(57) ABSTRACT

An inverter, particularly for the energy supply of a three-phase motor (3) of a motor vehicle, where the inverter comprises a half bridge (1a, 1b, 1c) for electrically conductively connecting to the three-phase motor (3). The half-bridge (1a, 1b, 1c) comprises a voltage limiting element (8) which is electrically conductively connected to an input (6b) and an output (6c) of a power semiconductor switch (5a; 5b) of the half bridge (1a, 1b, 1c). The voltage limiting element creates, in a defined manner, a high impedance or low impedance connection between the input (6b) and the output (6c) of the power semiconductor switch (5a; 5b), depending on the voltage value of a voltage present between the input (6b) and the output (6c) of the power semiconductor switch (5a; 5b).

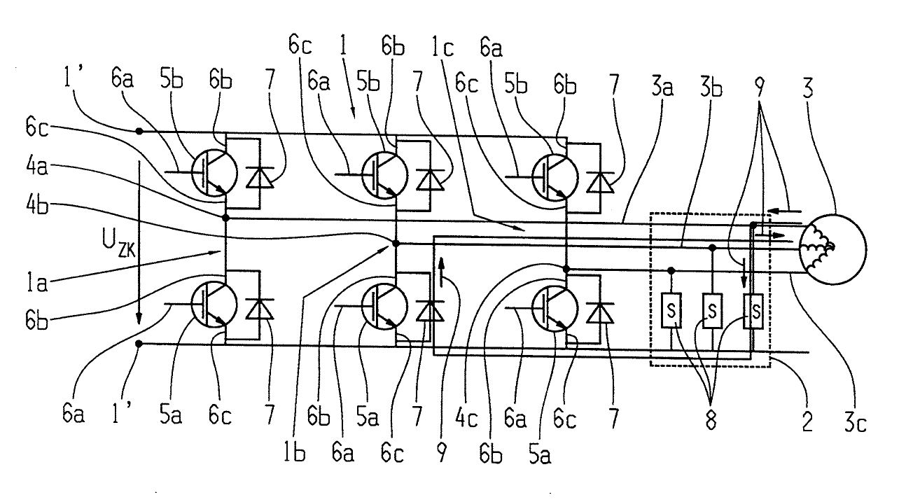

This application is a National Stage completion of PCT/EP2010/066425 filed Oct. 29, 2010, which claims priority from German patent application serial no. 10 2009 046 616.9 filed Nov. 11, 2009.

### FIELD OF THE INVENTION

The present invention relates to an inverter.

### BACKGROUND OF THE INVENTION

Converters and the like are used for controlling electric machines, wherein the machines are supplied, for example, by means of a direct current source, for instance a battery; however, one or more alternating current phases are required for operation. Such machines are particularly those in the field of motor vehicle drive engineering, such as three-phase motors, for instance permanently excited or externally excited synchronous motors.

A converter comprises a motor-side inverter, or respectively a drive inverter, for converting direct voltage from, for example, an intermediate circuit of the converter, particularly from an intermediate circuit with an intermediate circuit capacitor, into an alternating voltage at the desired frequency for controlling the direction of rotation and the rotational speed of the three-phase motor to be driven. Such drive inverters are used in particular in motor vehicles, for example in electrically driven motor vehicles or in vehicles with a hybrid drive, wherein the three-phase motor is designed as vehicle drive motor.

Such vehicle drive motors, particularly permanently excited synchronous motors, typically display the design-dependent behavior that during operation a counter-voltage, or respectively an internal voltage (synchronous generated voltage), is induced which increases with increasing rotational speed, and which at very high rotational speeds is supplied, or fed back, into the intermediate circuit particularly by means of the free-wheeling diodes of the (drive) inverter, and can lead to damage in the converter or the inverter, the battery, and further components (reverse voltage transfer). In the prior art, in order to be able to avoid this damage, while still being able to operate the motor at high speeds, a field weakening is applied above the rated rotational speed in order to avoid such a damaging reverse voltage transfer. Nevertheless, damage to the converter or further components is possible even with the use of field weakening, particularly if a motor is operated above the rated rotational speed (field weakening operation), and a field weakening current can no longer be maintained, for example. This can be caused by malfunctioning control electronics, for example.

In order to protect the converter from damaging reverse voltage transfer in the case of an unintended voltage increase on the side of the alternating voltage (thus, originating from the motor), the prior art proposes various protective circuits. Typically, for this purpose, power semiconductor circuits of the converter, or its motor side inverter, and thus the respective motor terminals connected therewith, are short-circuited for example. Short-circuiting via the bridge circuit can prevent damage to the intermediate circuit capacitor, a battery, the power switch, etc., for example, and with it the converter, caused by the induced voltage as a consequence of the rotation of the rotor. The known arrangements have a weakness however, in that in most cases the short circuit must be performed actively by control electronics of the inverter. In the event that the control electronics fail, no protection mechanism is provided against damage which occurs due to the voltage induced in the synchronous machine, or in the motor.

The document DE 102 51 977 A1 discloses a synchronous motor with an inverter, where a complex protection mechanism against reverse voltage transfer is connected to the winding phases, where the protection mechanism interacts with the control logic of the inverter for detecting a failure, or for protection against reverse voltage transfer. The document DE 298 13 080 U1, shows a further protection mechanism, connected to the windings of a motor, for protecting against reverse voltage transfer, where the protection mechanism in turn has electronics connected to the control logic for producing the protection function. This system is also complex and costly to produce. The document DE 198 35 576 A1 discloses a control system for a permanently excited electric motor which contains a unit to detect operating conditions in order to short circuit, if required, the power semiconductor switch by means of a control arrangement of the inverter. The arrangement, as with the prior arrangements, is also complex, costly and cannot be implemented without control logic.

### SUMMARY OF THE INVENTION

Proceeding from this background, the object addressed by the present invention is to solve the problems described above, and to propose an inverter which provides appropriate protection against reverse voltage transfer from a three-phase motor in a simple manner and without involving the control logic of the inverter.

An inverter according to the invention, particularly for the energy supply of a three-phase motor of a motor vehicle, is proposed where the inverter comprises a half bridge for electrically connecting to the three-phase motor, where the half bridge comprises an electrically conductive voltage limiting element electrically connected to an input and an output of a power semiconductor switch of the half bridge, where the voltage limiting element creates a high impedance or low impedance connection between the input and the output of the power semiconductor switch depending on the voltage value (value and polarity) of a voltage present between the input and the output of the power semiconductor switch.

Further, an inverter according to the invention is proposed in which each half bridge of the inverter is provided a voltage limiting element electrically conductively connected to an input and an output of a power semiconductor switch of the half bridge, where the voltage limiting element creates a high impedance or low impedance connection between the input and the output of the power semiconductor switch depending on the voltage value (value and polarity) of a voltage present between the input and the output of the power semiconductor switch of the respective half bridge.

In one embodiment according to the invention, the inverter is designed such that due to the low impedance connection, current flow is possible through the respective voltage limiting element in the direction from the input to the output of the respective power semiconductor switch. In one embodiment, due to the low impedance connection, particularly in each case, current flow through the respective voltage limiting element is possible, antiparallel or in the opposing direction, to the current flow direction through a free-wheeling diode connected to the input and the output of the respective power semiconductor switch.

According to a further embodiment of the inverter according to the invention, the voltage limiting element is disposed in the reverse direction between the input and the output, where the voltage limiting element becomes conductive in the reverse direction after reaching a defined voltage value between the input and the output.

In yet a further embodiment of the inverter, the voltage limiting element comprises an active and/or a passive element. The voltage limiting element can comprise a comparator and/or a controlled power switch, particularly a semiconductor switch or a mechanical switch. The voltage limiting element can comprise a zener diode and/or a suppressor diode and/or a varistor. The voltage limiting element can be constructed particularly of exactly one component, or can comprise exactly one such component.

A drive arrangement, particularly of a motor vehicle, is also proposed which comprises a three-phase motor, wherein for supplying electrical energy, a winding strand of the three-phase motor is electrically conductively connected to the half bridge of an inverter according to the invention.

In a further embodiment of the drive arrangement according to the invention, every winding strand of the three-phase motor is electrically conductively connected to a respective half bridge of the inverter. The three-phase motor can be a synchronous motor, particularly a permanently excited or externally excited synchronous motor.

Further features and advantages of the invention arise from the following description of example embodiments of the invention based on the figure of the drawing which shows individual details essential to the invention, and from the claims. The individual features can be implemented alone or combined in any combination in a variant of the invention.

### BRIEF DESCRIPTION OF THE DRAWINGS

Preferred embodiments of the invention are explained in the following in more detail using the attached drawing. The sole figure shows:
an example of a bridge circuit of an inverter according to a possible embodiment of the invention.

### DETAILED DESCRIPTION OF THE PREFERRED EMBODIMENTS

Elements that are the same or have the same function in the following description and the FIGURE have the same reference numbers.

The FIGURE shows a bridge circuit 1 of a drive inverter, or inverter, according to the invention, comprising a voltage limiting arrangement 2, particularly for protecting against reverse voltage transfer from a motor, for example, a three-phase motor 3, particularly an externally excited or permanently excited synchronous motor. The (drive) inverter is, for example, part of a converter known in the prior art.

A converter comprises in a known manner, for example, a rectifier (not shown) that supplies an intermediate circuit, in which an intermediate circuit capacitor is disposed, for example. The intermediate circuit supplies an intermediate circuit voltage U_{ZK} for example, particularly as a direct voltage, at the input 1′ of the inverter 2 for example, for the bridge circuit 1 of the inverter, for generating the alternating voltage provided for operating the motor. The inverter generates an alternating voltage for example, as an output voltage with variable voltage and frequency, in order to control the direction of rotation and rotational speed of the three-phase motor 3 connectable or connected thereto, for example.

The intermediate circuit voltage U_{ZK} is present at the input terminal 1′, for example, of the bridge circuit 1, which has a half bridge 1a, 1b, 1c, for example, each of which is electrically connectable or connected, for example via a center tap 4a, or 4b, 4c, in a known manner to a winding strand 3a, 3b, 3c of the three-phase motor 3. Here, the three-phase motor 3 is designed as a three-phase motor, whose winding strands 3a, 3b, 3c are each supplied by a half bridge 1a, 1b, 1c, for example. A voltage, or a potential, of predetermined polarity is delivered for a defined duration to each strand 3a, 3b, 3c of the three-phase motor 3 by the respective half bridge 1a, 1b, 1c. For this purpose, each of the power semiconductor switches 5a, 5b of the half bridges 1a, 1b, 1c are each correspondingly controlled in a known manner by means of control logic, for example.

A half bridge 1a, 1b, 1c comprises, for example, a first power semiconductor switch 5a, and a second power semiconductor switch 5b, which are in the form, for example, of a bipolar transistor with an insulated gate electrode (insulated gate bipolar transistor, IGBT) or as a field-effect transistor (FET), in the form, for example, of a metal-oxide-semiconductor field-effect transistor (MOSFET). The power semiconductor switches 5a, 5b are designed and appropriately dimensioned, particularly for the voltages occurring in a converter or in the drive inverter, for example. However, further power semiconductor switches are also conceivable.

The power semiconductor switches 5a, 5b each comprise a control input 6a, for example in the form of a gate electrode, and an input 6b, for example in the form of a collector electrode (IGBT) or a drain electrode (MOSFET) and an output 6c, for example in the form of an emitter electrode (IGBT) or source electrode (MOSFET). A free-wheeling diode 7 is connected in parallel in a customary manner between the input 6b and the output 6c, for example, particularly connected in parallel in the reverse direction.

The power semiconductor switches 5a (lower row), 5b (upper row) are, as discussed above, controlled via the respective control input 6a thereof, or control connection, in a known manner, for example by control electronics (not shown), where as a result of the control, a short circuit can be produced between the input 6b and the output 6c, in other words, the power semiconductor 5a or 5b is switched on.

The inverter according to the invention comprises a voltage limiting arrangement 2, which is formed by a voltage limiting element 8 for example, particularly formed by a voltage limiting element 8 for each half bridge 1a, or 1b, 1c. Here, the voltage limiting element 8 is in each case in the associated half bridge 1a, 1b, 1c electrically connected to the input 6b of the power semiconductor switch 5a and to the output 6c thereof, and therefore with the low impedance in the intended direction of current flow, is suited to bridge them. Additionally, the input 6b is electrically connected to the center tap 4a or 4b, 4c of the associated half bridge 1a, or 1b, 1c. The voltage limiting element 8 is disposed or connected in each case in parallel between, or in parallel to, the input 6b and the output 6c of the respective power semiconductor switch 5a, and is disposed in parallel to the respective free-wheeling diode 7 of the power semiconductor switch 5a, wherein the free-wheeling diode is also connected respectively to the input 6b and the output 6c of the power semiconductor switch 5a or 5b.

According to the invention it is also provided to dispose a voltage limiting element 8 in parallel to a free-wheeling diode 7, or to an input 6b and an output 6c of a power semiconductor switch 5b of the upper row, in particular for each half bridge 1a, 1b, 1c. With such an arrangement, the arrangement at the power semiconductor switches 5a of the lower row can be omitted.

The voltage limiting element 8 of the voltage limiting arrangement 2 is provided according to the invention so that in the case of a reverse voltage transfer from the motor, the induced terminal voltage, or voltage of the three-phase motor 3, is set or limited to a defined (threshold) value. The defined value, or the pre-determined threshold voltage, is selected so that the voltage is not hazardous, or that no hazard is anticipated, for the converter and other components to be protected. Voltage limiting from a defined threshold value can be attained solely by the voltage limiting element 8 in the form of one or more suitably selected components, and particularly without interaction, for instance, with the control logic of the converter, thus, in this respect self-sufficiently.

The properties of the selected components enable an appropriate threshold setting, thereby specifying the voltage from which limiting occurs. For instance, the potentially damaging voltage surges of the induced voltage are clipped or suppressed by means of the voltage limiting element(s) 8. In doing so, the three-phase motor is braked until the voltage drops to a non-hazardous voltage value. The voltage limiting elements 8 are each, for example, of high impedance, particularly in the provided reverse direction thereof, until the voltage present at them, or between the input 6b and the output 6c respectively, attains the provided threshold voltage. Starting from the threshold voltage, or after exceeding threshold voltage, as a consequence of reverse voltage transfer from the motor 3, the voltage limiting elements 8 are each low impedance, particularly low impedance in the intended current flow direction from the input 6b to the output 6c for example. The elements are conducting in the reverse direction thereof. In this regard, a voltage limiting element 8 connects the input 6b and the output 6c of a respective power semiconductor switch 5a or 5b, depending on the voltage value of the voltage present between the input 6b and the output 6c, in a defined high impedance or low impedance manner, which is to say substantially non-conducting or conducting.

The inverter is designed such that due to the low impedance connection through voltage limiting element 8, after reaching the threshold value, current flow is possible through the respective voltage limiting element 8 in the direction from the input 6b to the output 6c of the respective power semiconductor switch 5a or 5b. In other words, in the case of attaining the threshold voltage, thus in the case of a low impedance connection, the voltage limiting element becomes conducting in the reverse direction thereof. The reverse direction of the voltage limiting element 8 disposed between the input 6b and the output 6c corresponds particularly to the reverse direction of the free-wheeling diode 7, for example.

Due to the low impedance connection in particular, for example, in each case current flow is possible through the respective voltage limiting element 8 in the opposing direction, or antiparallel, to the intended or provided current flow direction through the free-wheeling diode 7 connected to the input 6b and the output 6c of the respective power semiconductor switch. Thus, a current 9 can flow, for example, from a winding strand 3a of the motor 3 via the low impedance voltage limiting element 8, and a free-wheeling diode 7, for example to a further winding strand 3b of the motor 3.

Various components can be used as a voltage limiting element 8 for guaranteeing this function, for instance elements that are externally switchable or elements that are integrated into the inverter. A voltage limiting element 8 can comprise an active component (element), which allows control for example, or can comprise a passive component (element), or can be designed as such in each case.

The voltage limiting element 8 can comprise, for example, an arrangement of several components, for instance a device comprising a comparator, which detects a voltage surge or exceeding the threshold voltage as a consequence of a reverse voltage transfer for example, and as a result can actuate a power switch, whose conductivity (on/off) can be controlled depending on the detected voltage value. The power switch can be a semiconductor switch, for example a transistor switch, or for example a mechanical switch, for instance a relay. It is also conceivable to use a power Z-diode (the switch is substantially a zener diode with a transistor, for example a complementary Darlington stage) for example, or a so-called known thyristor crowbar, as a voltage limiting element 8.

The voltage limiting element 8 can be a passive element, for instance a zener diode, which after reaching the breakdown voltage selected as the threshold voltage thereof, is conducting, or of low impedance, in the reverse direction, a suppressor diode or for example a varistor, i.e. a voltage-dependent impedance. It is conceivable to provide different types of voltage limiting elements 8 within an inverter for example, for each half bridge 1a, 1b, 1c of different types for forming a voltage limiting arrangement 2. All of the voltage limiting elements 8, or the voltage limiting arrangement 2 according to the invention, limit the voltage self-sufficiently, or independently, i.e., solely depending on the voltage present at the voltage limiting element 8, for example as a consequence of a reverse voltage transfer. In this respect, a voltage limiting element 8, or voltage limiting arrangement 2 according to the invention, is independent of a control of the, or by the, inverter(s), converter(s) or motor(s), etc. Further components, particularly a circuit of external signal sources such as those of control logic for the converter or inverter that controls the power semiconductor for example, are not additionally provided for the voltage limiting according to the invention.

The voltage limitation according to the invention, in which due to a voltage limiting element 8, particularly connected in each case to a free-wheeling diode 7, a conductive connection is created between every two terminals of the motor 3 at least starting from a potentially damaging reverse voltage transfer, or from exceeding a threshold value, produces a braking torque for example, which can cause braking of the motor in a motor decoupled from the drive train, i.e., the speed is reduced until the voltage decreases to a non-hazardous value. With a motor connected to the drive train, for instance, the entire drive train is braked, wherein the resulting brake torque is however substantially less than a short-circuit braking torque.

A current flow 9 flowing in the three-phase motor 3 and the inverter as a consequence of the reverse voltage transfer, with an active voltage limitation, for example, due to the voltage limiting element 8, thus flows (as soon as the voltage limiting element 8 is of low impedance, or conductive, or electrically conducting, as a consequence of, for example, excess terminal voltage, which is present between the center tap 4a and 4b for instance) from a first terminal of the three-phase motor 3 connected to the center tap 4a, through the voltage limiting element 8 of the voltage limiting arrangement 2, via the free-wheeling diode 7, back to a further terminal of the motor 3 connected to the center tap 4b.

### REFERENCE CHARACTERS

1 bridge circuit

1′ input terminals

1c, 1b, 1c half bridge

2 voltage limiting arrangement

3 motor

3a, 3b, 3c winding strand

4a, 4b, 4c half bridge

5a power semiconductor switch (lower row)

5b power semiconductor switch (upper row)

6a control input power semiconductor switch

6b input of the power semiconductor switch

6c output of the power semiconductor switch

7 free-wheeling diode

8 voltage limiting element

9 current

1-12. (canceled)

13. An inverter for an energy supply of a three-phase motor (3) of a motor vehicle, the inverter comprising:
a half bridge (1a, 1b, 1c) for electrically conductively connecting to the three-phase motor (3),
the half-bridge (1a, 1b, 1c) comprising a voltage limiting element (8) which is electrically conductively connected to an input (6b) and an output (6c) of a power semiconductor switch (5a; 5b) of the half bridge (1a, 1b, 1c) and which creates either a high impedance or a low impedance connection between the input (6b) and the output (6c) of the power semiconductor switch (5a; 5b), depending on a voltage value of a voltage present between the input (6b) and the output (6c) of the power semiconductor switch (5a; 5b).

14. The inverter according to claim 13, wherein each half-bridge (1a, 1b, 1c) of the inverter is provided with a voltage limiting element (8) which is electrically conductively connected to an input (6b) and an output (6c) of a respective power semiconductor switch (5a; 5b) of the half bridge (1a, 1b, 1c), and which creates in a defined manner either a high impedance or a low impedance connection between the input (6b) and the output (6c) of the respective power semiconductor switch (5a; 5b) depending on the voltage value of the voltage present between the input (6b) and the output (6c) of the power semiconductor switch (5a; 5b) of the respective half bridge (1a, 1b, 1c).

15. The inverter according to claim 13, wherein due to the low impedance connection, current flow is possible through the respective voltage limiting element (8) in a direction from the input (6b) to the output (6c) of the respective power semiconductor switch (5a; 5b).

16. The inverter according to claim 13, wherein due to the low impedance connection in each case, current flow through the respective voltage limiting element (8) is possible, in an opposite direction to a current flow direction through a free-wheeling diode (7) connected to the input (6b) and the output (6c) of the respective power semiconductor switch (5a; 5b).

17. The inverter according to claim 13, wherein the voltage limiting element is disposed in a reverse direction between the input and the output, the voltage limiting element becomes conducting in the reverse direction after attaining a defined voltage value present between the input and the output.

18. The inverter according to claim 13, wherein the voltage limiting element (8) comprises at least one of an active and a passive element.

19. The inverter according to claim 13, wherein the voltage limiting element (8) comprises at least one of a comparator and a power switch.

20. The inverter according to claim 13, wherein the voltage limiting element (8) comprises at least one of a zener diode and a suppressor diode and a varistor.

21. The inverter according to claim 13, wherein the voltage limiting element (8) comprises exactly one component.

22. A drive arrangement of a motor vehicle containing a three-phase motor (3) in combination with an inverter for supplying electrical energy to the three-phase motor (3), the drive arrangement comprising:
a winding strand (3a, 3b, 3c) of the three-phase motor (3) which is electrically conductively connected to a half bridge (1a, 1b, 1c),
the inverter comprising the half bridge (1a, 1b, 1c) for electrically conductively connecting to the three-phase motor (3),
the half-bridge (1a, 1b, 1c) comprising a voltage limiting element (8) which is electrically conductively connected to an input (6b) and an output (6c) of a power semiconductor switch (5a; 5b) of the half bridge (1a, 1b, 1c) and which creates either a high impedance or a low impedance connection between the input (6b) and the output (6c) of the power semiconductor switch (5a; 5b), depending on a voltage value of a voltage present between the input (6b) and the output (6c) of the power semiconductor switch (5a; 5b).

23. The drive arrangement according to claim 22, wherein each winding strand (3a, 3b, 3c) of the three-phase motor (3) is electrically conductively connected to a half bridge (1a, 1b, 1c) of the inverter.

24. The drive arrangement according to claim 22, wherein the three-phase motor (3) is one of a synchronous motor, a permanently excited motor and an externally excited synchronous motor.

25. An inverter for an energy supply of a three-phase motor (3) of a motor vehicle, the inverter comprising:
three half bridges (1a, 1b, 1c) which electrically conductively connect to a respective phase of the three-phase motor (3),
each of the three half-bridges (1a, 1b, 1c) comprising a voltage limiting element (8) which is electrically conductively connected to an input (6b) and an output (6c) of a power semiconductor switch (5a; 5b) of the respective half bridge (1a, 1b, 1c) and which creates either a high impedance or low impedance connection between the input (6b) and the output (6c) of the power semiconductor switch (5a; 5b), depending on a value of a voltage present between the input (6b) and the output (6c) of the power semiconductor switch (5a; 5b).
